(19) United States
(12) Patent Application Publication
(10) Pub. No.: US 2026/0156561 A1
(43) Pub. Date: Jun. 4, 2026

(54) METHOD AND APPARATUS FOR NETWORK FUNCTION DISCOVERY

(71) Applicant: Telefonaktiebolaget LM Ericsson (publ), Stockholm (SE)

(72) Inventors: Qingqing MAO, Shanghai (CN); Jian TONG, Shanghai (CN); Yunjie LU, Shanghai (CN)

(21) Appl. No.: 19/123,264

(22) PCT Filed: Sep. 13, 2023
(86) PCT No.: PCT/CN2023/118566

§ 371 Date: Apr. 22, 2025

(30) Foreign Application Priority Data
Oct. 28, 2022 (WO) PCT/CN2022/128328

(51) Int. Cl. H04W 48/16; H04L 67/51

(52) U.S. Cl. CPC H04W 48/16; H04L 67/51

(57) ABSTRACT

Embodiments of the present disclosure provide method and apparatus for NF discovery. A method performed by a first network repository function (NRF) comprises receiving a first network function (NF) discovery request comprising at least one preferred feature to be supported by a target network function from a first network node. The method further comprises sending a first NF discovery response to the first network node. The first response comprises first information indicating whether a search result includes at least one NF profile that supports the at least one preferred feature, and/or second information indicating whether the search result includes at least one NF profile that does not support the at least one preferred feature.

### TECHNICAL FIELD

The non-limiting and exemplary embodiments of the present disclosure generally relate to the technical field of communications, and specifically to methods and apparatuses for network function (NF) discovery.

### BACKGROUND

This section introduces aspects that may facilitate a better understanding of the disclosure. Accordingly, the statements of this section are to be read in this light and are not to be understood as admissions about what is in the prior art or what is not in the prior art.

In some networks, a feature negotiation mechanism has been introduced to help NF service consumer and NF service producer to negotiate applicable optional features.

For example, in 3GPP (Third Generation Partnership Project) 5GS (5th Generation system), feature negotiation was introduced to allow an NF service consumer and an NF service producer exchange supported features of a service. When NRF is used for NF discovery, the NF service consumer may expect to discover the NF service producer supporting certain features.

For example, clause 6.6.2 of 3GPP TS 29.500 V17.8.0, the disclosure of which is incorporated by reference herein in its entirety, describes the feature negotiation as following.

“Additionally, a NF instance should register all the features it supports to the NRF (Network Repository Function), to enable NF service consumers to discover NF service producers supporting specific features. A NF instance should register all the features it supports as NF service consumer in the corresponding default notification subscription in its NF profile to the NRF, to enable NF service producer to select NF service consumer supporting specific features.”

Each NF may register its supported features in NRF. When an NF service consumer wants to discover a target NF supporting specific features, “supported-features” or “required-features” can be included as query parameter in an NF discovery request.

The description of “supported-features” and “required-features” can be found in Table 1, which is a copy from the Table 6.2.3.2.3.1-1 of 3GPP TS 29.510 V18.0.0, the disclosure of which is incorporated by reference herein in its entirety.

TABLE 1

| Name | Data type | P | Cardinality | Description | Applicability |
|---|---|---|---|---|---|
| supported- | SupportedFeatures | O | 0 . . . 1 | List of features required to be supported by the target Network | |
| features | | | | Function. | |
| | | | | This IE may be present only if the service-names attribute is present | |
| | | | | and if it contains a single service-name. It shall be ignored by the | |
| | | | | NRF otherwise. | |
| | | | | (NOTE 4) | |
| required- | array(SupportedFeatures) | O | 1 . . . N | List of features required to be supported by the target Network | Query-Params- |
| features | | | | Function, as defined by the supportedFeatures attribute in NFService | Ext1 |
| | | | | (see clauses 6.1.6.2.3 and 6.2.6.2.4). | |
| | | | | This IE may be present only if the service-names attribute is present. | |
| | | | | When present, the required-features attribute shall contain as many | |
| | | | | entries as the number of entries in the service-names attribute. The | |
| | | | | n^{th} entry in the required-features attribute shall correspond to the n^{th} | |
| | | | | entry in the service-names attribute. An entry corresponding to a | |
| | | | | service for which no specific feature is required shall be encoded as | |
| | | | | “0”. | |

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to Table 1, if “supported-features” or “required-features” query parameter is included in the NF discovery request, the NRF shall return target NFs supporting the specific features. If no NFs supporting the specific features, the NF discovery is failed due to no NF instances can be returned from NRF.

Supported features are mostly some additional functions introduced in later versions in 5G (fifth generation) API (Application Programming Interface) and can help to manage backwards capability. When the NF service consumer has supported some specific supported features, it should prefer to select NF service producer supporting the required specific features and perform the additional function introduced by the features.

Based on current specification (such as 3GPP TS 29.510 V18.0.0) of 3GPP, only “supported-features” or “required-features” query parameter can be used to find target NFs supporting specific features. When no target NF supports the specific features, the NF discovery is failed. So, the NF service consumer needs to send the NF discovery request twice or more times, which may introduce more signaling and cause long latency.

Sometimes, when no target NF supports the specific features, an operator may still want to select target NFs not supporting the specific features and perform other main functions in the API except for the additional functions introduced by the supported features. In a scenario, a 2nd NF discovery request message has to be sent out without the “required-features” query parameter or with less query parameter. Target NFs not supporting the required features can be returned in the 2nd NF discovery response.

For a particular use case, e.g. an AMF (Access and Mobility Management Function) selects an SMF (Session Management Function), some of the features may be mandatory (like CP (control plane) CIOT (Cellular Internet of Things)) to be supported while some of the features may be preferred only (e.g. DTSSA (Deployments Topologies with specific SMF Service Areas)). However, currently NRF only supports query parameter mandating the required features, not preferred features. If AMF includes all the expected features (mandatory and preferred) in the query parameters, the NRF may fail to find candidate SMF for the PDU session and AMF needs to make new discovery with less features. If AMF only includes mandatory features, the NRF may return only the candidate SMFs not supporting preferred features (due to limited numbers of candidate in discovery result) even when other SMFs supporting the preferred features.

To overcome or mitigate at least one of above mentioned problems or other problems, the embodiments of the present disclosure propose an improved solution for NF discovery.

In an embodiment, to help the NF service consumer efficiently discover the candidate NF service producers based on mandatory and preferred features, the NF service consumer can indicate the preferred features in the discovery request besides the required features. The NRF may prioritize the matched candidates supporting preferred features in the search result.

In a first aspect of the disclosure, there is provided a method performed by a first network repository function (NRF). The method comprises receiving a first network function (NF) discovery request comprising at least one preferred feature to be supported by a target network function from a network node. The method further comprises sending a first NF discovery response to the network node.

In an embodiment, the first NF discovery response comprises first information indicating whether a search result includes at least one NF profile that supports the at least one preferred feature, and/or second information indicating whether the search result includes at least one NF profile that does not support the at least one preferred feature.

In an embodiment, the first information is a Boolean value and the second information is a Boolean value.

In an embodiment, when the first information is set to true and the second information is set to false, it indicates all returned NF instances match the at least one preferred feature.

In an embodiment, when the first information is set to false and the second information is set to true, it indicates that none of all returned NF instances matches the at least one preferred feature.

In an embodiment, when the first information is set to true and the second information is set to true, it indicates that at least one returned NF instance matches the at least one preferred feature and at least one returned NF instance does not match the at least one preferred feature.

In an embodiment, when the first information is set to false and the second information is set to false, it indicates that no NF instance can be found.

In an embodiment, the method further comprises determining at least one first NF instance matching the at least one preferred feature.

In an embodiment, the method further comprises determining at least one second NF instance not matching the at least one preferred feature.

In an embodiment, the first NF discovery response comprises information regarding the at least one first NF instance and/or information regarding the at least one second NF instance.

In an embodiment, determining at least one second NF instance not matching the at least one preferred feature comprises determining the at least one second NF instance not matching the at least one preferred feature when the at least one first NF instance cannot be found or a number of the at least one first NF instance is smaller than a predefined number.

In an embodiment, the method further comprises setting a priority for the at least one first NF instance.

In an embodiment, the method further comprises setting a priority for the at least one second NF instance.

In an embodiment, the at least one first NF instance is set with a higher priority to be selected than the at least one second NF instance.

In an embodiment, the first NF discovery response further comprises information regarding the priority of at least one first NF instance and/or the priority of the at least one second NF instance.

In an embodiment, the method further comprises sending a second NF discovery request comprising the at least one preferred feature to a second NRF.

In an embodiment, the method further comprises receiving a second NF discovery response from the second NRF.

In an embodiment, the second NF discovery response and the first NF discovery response comprise information regarding at least one third NF instance matching the at least one preferred feature and/or information regarding at least one fourth NF instance not matching the at least one preferred feature.

In an embodiment, when the at least one third NF instance cannot be found or a number of the at least one third NF instance is smaller than a predefined number, the second NF discovery response and the first NF discovery response comprise the at least one fourth NF instance not matching the at least one preferred feature.

In an embodiment, the at least one third NF instance is set with a priority and/or the at least one fourth NF instance is set with a priority.

In an embodiment, the at least one third NF instance is set with a higher priority to be selected than the at least one fourth NF instance.

In an embodiment, the second NF discovery response and the first NF discovery response further comprise information regarding the priority of at least one third NF instance and/or the priority of the at least one fourth NF instance.

In an embodiment, the method further comprises receiving information indicating that the second NRF supports a query parameter of preferred features from the second NRF.

In an embodiment, the second NF discovery response comprises at least one of third information indicating whether a search result includes at least one NF profile that supports the at least one preferred feature, or fourth information indicating whether the search result includes at least one NF profile that does not support the at least one preferred feature.

In an embodiment, the third information is a Boolean value and the fourth information is a Boolean value.

In an embodiment, when the third information is set to true and the fourth information is set to false, it indicates all returned NF instances match the at least one preferred feature.

In an embodiment, when the third information is set to false and the fourth information is set to true, it indicates that none of all returned NF instances matches the at least one preferred feature.

In an embodiment, when the third information is set to true and the fourth information is set to true, it indicates that at least one returned NF instance matches the at least one preferred feature and at least one returned NF instance does not match the at least one preferred feature.

In an embodiment, when the third information is set to false and the fourth information is set to false, it indicates that no NF instance can be found.

In an embodiment, the method further comprises sending information indicating that the first NRF supports a query parameter of preferred features to the network node.

In an embodiment, the network node comprises at least one of an NF service consumer, an NRF, or a service communication proxy (SCP).

In a second aspect of the disclosure, there is provided a method performed by a first network node. The method comprises sending a first request comprising at least one preferred feature to be supported by a target network function to a second network node. The method further comprises receiving a first response from the second network node.

In an embodiment, the first response comprises first information indicating whether a search result includes at least one NF profile that supports the at least one preferred feature, and/or second information indicating whether the search result includes at least one NF profile that does not support the at least one preferred feature.

In an embodiment, the first information is a Boolean value and the second information is a Boolean value.

In an embodiment, when the first information is set to true and the second information is set to false, it indicates all returned NF instances match the at least one preferred feature.

In an embodiment, when the first information is set to false and the second information is set to true, it indicates that none of all returned NF instances matches the at least one preferred feature.

In an embodiment, when the first information is set to true and the second information is set to true, it indicates that at least one returned NF instance matches the at least one preferred feature and at least one returned NF instance does not match the at least one preferred feature.

In an embodiment, when the first information is set to false and the second information is set to false, it indicates that no NF instance can be found.

In an embodiment, the first response comprises information regarding the at least one NF instance matching the at least one preferred feature and/or information regarding the at least one NF instance not matching the at least one preferred feature.

In an embodiment, when the at least one NF instance matching the at least one preferred feature cannot be found or a number of the at least one NF instance matching the at least one preferred feature is smaller than a predefined number, the first response comprises the at least one NF instance not matching the at least one preferred feature.

In an embodiment, the at least one NF instance matching the at least one preferred feature is set with a priority and/or the at least one NF instance not matching the at least one preferred feature is set with a priority.

In an embodiment, the at least one NF instance matching the at least one preferred feature is set with a higher priority to be selected than the at least one NF instance not matching the at least one preferred feature.

In an embodiment, the first response further comprises information regarding the priority of at least one NF instance matching the at least one preferred feature and/or the priority of the at least one NF instance not matching the at least one preferred feature.

In an embodiment, the method further comprises receiving information indicating that the second network node supports a query parameter of preferred features from the second network node.

In an embodiment, the first network node comprises at least one of an NF service consumer, an NRF, or a service communication proxy (SCP).

In an embodiment, the second network node comprises at least one of an NRF, or a service communication proxy (SCP).

In an embodiment, the first request comprises at least one of an NF discovery request, or a service request.

In an embodiment, the first response comprises at least one of an NF discovery response, or a service response.

In an embodiment, when the first network node is an SCP and the second network node is an NRF, the method further comprises receiving a service request comprising the at least one preferred feature from an NF service consumer. The method further comprises sending a service response to the NF service consumer.

In an embodiment, the method further comprises selecting a target NF based on the first response.

In a third aspect of the disclosure, there is provided a first NRF. The first NRF comprises a processor and a memory coupled to the processor. Said memory contains instructions executable by said processor. Said first NRF is operative to receive a first network function (NF) discovery request comprising at least one preferred feature to be supported by a target network function from a network node. Said first NRF is further operative to send a first NF discovery response to the network node. The first NF discovery response comprises first information indicating whether a search result includes at least one NF profile that supports the at least one preferred feature, and/or second information indicating whether the search result includes at least one NF profile that does not support the at least one preferred feature.

In a fourth aspect of the disclosure, there is provided a first network node. The first network node comprises a processor and a memory coupled to the processor. Said memory contains instructions executable by said processor. Said first network node is operative to send a first request comprising at least one preferred feature to be supported by a target network function to a second network node. Said first network node is further operative to receive a first response from the second network node. The first response comprises first information indicating whether a search result includes at least one NF profile that supports the at least one preferred feature, and/or second information indicating whether the search result includes at least one NF profile that does not support the at least one preferred feature.

In a fifth aspect of the disclosure, there is provided a first NRF. The first NRF comprises a first receiving module configured to receive a first network function (NF) discovery request comprising at least one preferred feature to be supported by a target network function from a network node. The first NRF further comprises a first sending module configured to send a first NF discovery response to the network node. The first NF discovery response comprises first information indicating whether a search result includes at least one NF profile that supports the at least one preferred feature, and/or second information indicating whether the search result includes at least one NF profile that does not support the at least one preferred feature.

In an embodiment, the first NRF further comprises a first determining module configured to determine at least one first NF instance matching the at least one preferred feature.

In an embodiment, the first NRF further comprises a second determining module configured to determine at least one second NF instance not matching the at least one preferred feature. The first NF discovery response comprises information regarding the at least one first NF instance and/or information regarding the at least one second NF instance.

In an embodiment, the first NRF further comprises a first setting module configured to set a priority for the at least one first NF instance.

In an embodiment, the first NRF further comprises a second setting module configured to set a priority for the at least one second NF instance. The at least one first NF instance is set with a higher priority to be selected than the at least one second NF instance. The first NF discovery response further comprises information regarding the priority of at least one first NF instance and/or the priority of the at least one second NF instance.

In an embodiment, the first NRF further comprises a second sending module configured to send a second NF discovery request comprising the at least one preferred feature to a second NRF.

In an embodiment, the first NRF further comprises a second receiving module configured to receive a second NF discovery response from the second NRF.

In an embodiment, the first NRF further comprises a third receiving module configured to receive information indicating that the second NRF supports a query parameter of preferred features from the second NRF.

In an embodiment, the first NRF further comprises a third receiving module configured to send information indicating that the first NRF supports a query parameter of preferred features to the network node.

In a sixth aspect of the disclosure, there is provided a first network node. The first network node comprises a first sending module configured to send a first request comprising at least one preferred feature to be supported by a target network function to a second network node. The first network node further comprises a first receiving module configured to receive a first response from the second network node. The first response comprises first information indicating whether a search result includes at least one NF profile that supports the at least one preferred feature, and/or second information indicating whether the search result includes at least one NF profile that does not support the at least one preferred feature.

In an embodiment, the first NF further comprises a second receiving module configured to receive information indicating that the second NF supports a query parameter of preferred features from the second NF.

In an embodiment, the first NF further comprises a third receiving module configured to receive a service request comprising the at least one preferred feature from an NF service consumer.

In an embodiment, the first NF further comprises a second sending module configured to send a service response to the NF service consumer.

In an embodiment, the first NF further comprises a selecting module configured to select a target NF based on the first response.

In another aspect of the disclosure, there is provided a computer program product comprising instructions which when executed by at least one processor, cause the at least one processor to perform the method according to any one of the first or second aspects.

In another aspect of the disclosure, there is provided a computer-readable storage medium storing instructions which when executed by at least one processor, cause the at least one processor to perform the method according to any one of the first or second aspects.

Embodiments herein may provide many advantages, of which a non-exhaustive list of examples follows. In some embodiments herein, a new query parameter “preferred-features” can be utilized in NF discovery request, which can provide a new approach for discovering target NF instances supporting specific features. As all supported NF instances can be retrieved in one-time NF discovery, and the NF Instances matching the preferred features are of higher priority than the not matched ones. In some embodiments herein, the proposed solution can help to reduce NF discovery signaling. In some embodiments herein, the proposed solution can help to provide more available NF candidates during NF reselection. In some embodiments herein, in the NF discovery response, the NRF can provide indications about whether matched NF instances are found, and/or whether not matched NF instances are included. In some embodiments herein, the NF service consumer can decide how to interact with NF service producer based on the provided indications, which can better support the feature negotiation mechanism. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 schematically shows a high level architecture in the fifth generation network according to an embodiment of the present disclosure;

FIG. 2 shows a flowchart of NF discovery;

FIG. 3 shows a flowchart of a method according to an embodiment of the present disclosure;

FIG. 4a shows a flowchart of a method according to another embodiment of the present disclosure;

FIG. 4b shows a flowchart of a method according to another embodiment of the present disclosure;

FIG. 4c shows a flowchart of a method according to another embodiment of the present disclosure;

FIG. 4d shows a flowchart of a method according to another embodiment of the present disclosure;

FIG. 5a shows a flowchart of a method according to another embodiment of the present disclosure;

FIG. 5b shows a flowchart of a method according to another embodiment of the present disclosure;

FIG. 6 shows a flowchart of a method according to another embodiment of the present disclosure;

FIG. 7 shows a flowchart of NF discovery according to an embodiment of the present disclosure;

FIG. 8a is a block diagram showing an apparatus suitable for practicing some embodiments of the disclosure;

FIG. 8b is a block diagram showing a first NRF according to an embodiment of the disclosure; and

FIG. 9 is a block diagram showing a first network node according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HISPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols either currently known or to be developed in the future.

The term “network device” or “network node” refers to any suitable network function (NF) which can be implemented in a network entity (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and Mobility Management Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE (Long Term Evolution)) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (CNB), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment.” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for case of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

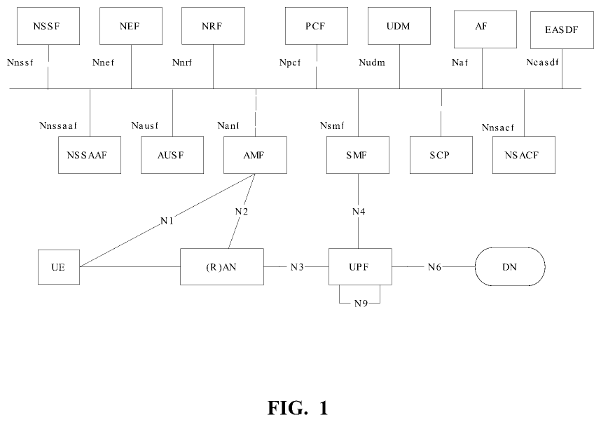

Although the subject matter described herein may be implemented in any appropriate type of system using any suitable components, the embodiments disclosed herein are described in relation to a communication system complied with the exemplary system architecture illustrated in FIG. 1. For simplicity, the system architecture of FIG. 1 only depicts some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

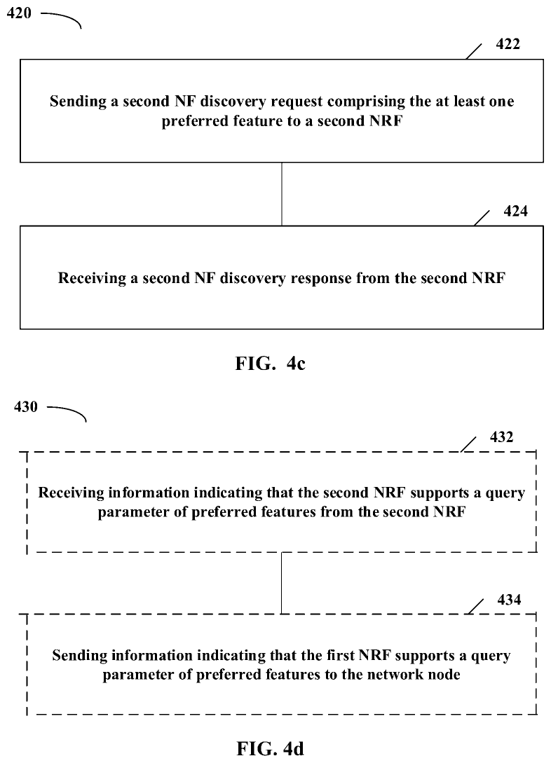

FIG. 1 schematically shows a high level architecture in the fifth generation network according to an embodiment of the present disclosure. For example, the fifth generation network may be 5GS. The architecture of FIG. 1 is same as FIG. 4.2.3-1 as described in 3GPP TS 23.501 V17.5.0, the disclosure of which is incorporated by reference herein in its entirety. The system architecture of FIG. 1 may comprise some exemplary elements such as AUSF, AMF, DN (data network), NEF. NRF, NSSF, PCF, SMF, UDM, UPF, AF, UE, (R)AN, SCP (Service Communication Proxy), NSSAAF (Network Slice-Specific Authentication and Authorization Function), NSACF (Network Slice Admission Control Function), Edge Application Server Discovery Function (EASDF), etc.

In accordance with an exemplary embodiment, the UE can establish a signaling connection with the AMF over the reference point N1, as illustrated in FIG. 1. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a protocol data unit (PDU) session to the DN (data network, e.g. an operator network or Internet) through the UPF over the reference point N6.

As further illustrated in FIG. 1, the exemplary system architecture also contains the service-based interfaces such as Nnrf, Nnef, Nausf, Nudm, Npcf, Namf, Nnsacf, Neasdf and Nsmf exhibited by NFs such as the NRF, the NEF, the AUSF, the UDM, the PCF, the AMF, the NSACF, the EASDF and the SMF. In addition, FIG. 1 also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

Various NFs shown in FIG. 1 may be responsible for functions such as session management, mobility management, authentication, security, etc. The AUSF, AMF, DN, NEF, NRF, NSSF, PCF, SMF, UDM, UPF, AF, UE, (R)AN, SCP, NSACF, EASDF may include the functionality for example as defined in clause 6.2 of 3GPP TS 23.501 V17.5.0.

The NRF can interact with every other NF in the 5GC (5G core network). Each NF may register the NF Profile in the NRF by Nnrf_NFManagement service, and discover other NF from the NRF by Nnrf_NFDiscovery service.

In 3GPP 5G APIs, supported features are defined and feature negotiation mechanism exists for NF service consumer and NF service producer to determine the supported features in the API.

According to clause 6.6.2 of 3GPP TS 29.500 V17.8.0, “NF Instances should register supported features to the NRF to enable NF service consumers to discover NF service producers supporting specific features.”

FIG. 2 shows a flowchart of NF discovery. It shows an example that AMF as NF service consumer prefers to discover SMF supporting DTSSA feature during PDU Session Establishment procedures. 2 times NF discovery request needs to be sent when “required-features” query parameter is used and no SMF supporting DTSSA exists in NRF.

In step 1, the UE sends a PDU Session Establishment Request to AMF.

In step 2, the AMF sends an Nnrf_NFDiscovery_Request to NRF. The “required-features” query parameter is included in the Nnrf_NFDiscovery_Request with DTSSA feature bit set.

In step 3, NRF sends an Nnrf_NFDiscovery_Response to AMF. No matched SMF instance is found in NRF and no SMF instance is included in the Nnrf_NFDiscovery_Response.

In step 4, the AMF still wants to find available SMF instances even it doesn't support DTSSA feature. AMF send a 2nd Nnrf_NFDiscovery_Request without “required-features” query parameter to NRF.

In step 5, the NRF may send Nnrf_NFDiscovery_Response comprising SMF instances matching the query criteria to AMF.

In step 6, the AMF sends an Nsmf_PDUSession_CreateSMContext to the SMF. The DTSSA feature related attributes will not be included in the Nsmf_PDUSession_CreateSMContext. And the PDU Session Establishment procedure continues.

Then steps 6 to 21 of PDU Session Establishment procedure in FIG. 4.3.2.2-1 of 3GPP TS 23.502 V17.5.0 may be performed.

The messages of FIG. 2 may be same as the corresponding messages as described in 3GPP TS 23.502 V17.5.0, the disclosure of which is incorporated by reference herein in its entirety.

So, the NF service consumer may need to send the NF discovery request twice or more times, which may introduce more signaling and cause long latency.

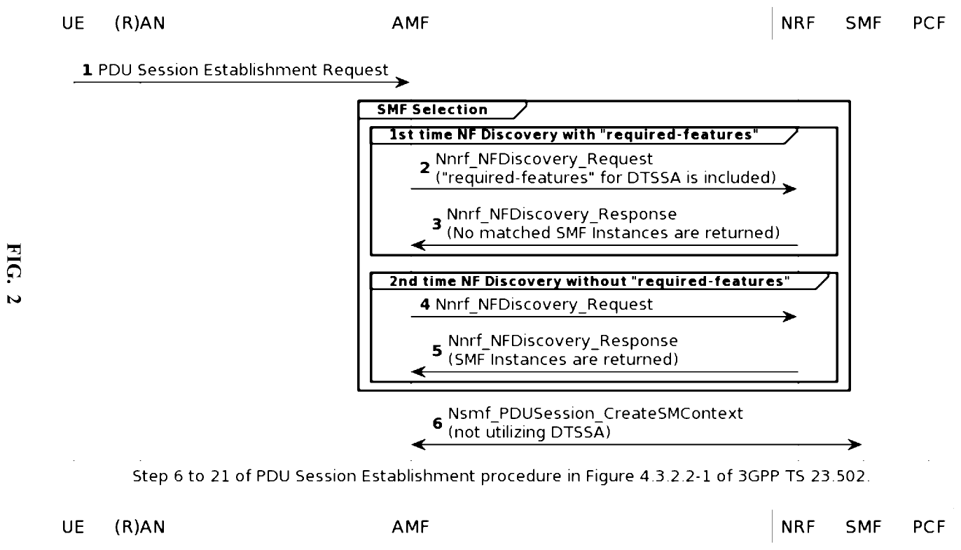

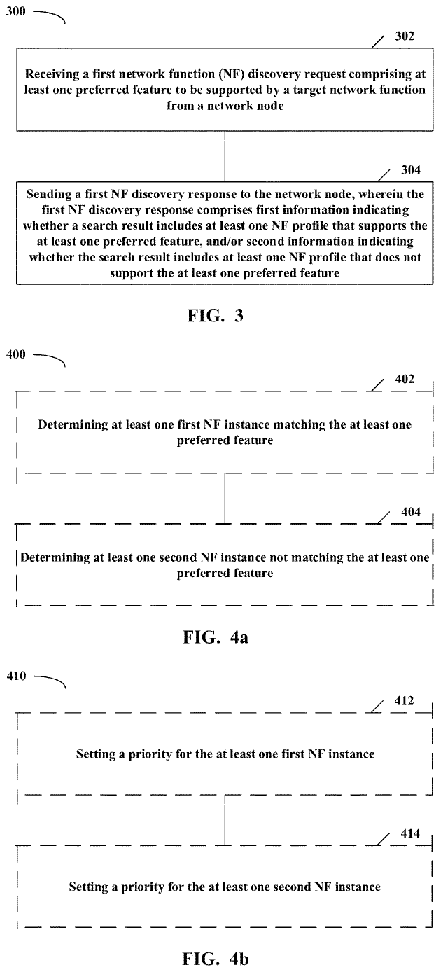

FIG. 3 shows a flowchart of a method according to an embodiment of the present disclosure, which may be performed by an apparatus implemented in or at or as a first network repository function (NRF) or communicatively coupled to the first NRF. As such, the apparatus may provide means or modules for accomplishing various parts of the method 300 as well as means or modules for accomplishing other processes in conjunction with other components.

At block 302, the first NRF may receive a first network function (NF) discovery request comprising at least one preferred feature to be supported by a target network function from a network node.

The network repository function may be any suitable network device or node or entity or function which can support NF discovery function and maintain the NF profile of available NF instances and their supported services. In an embodiment, the network repository function may be NRF as described in 3GPP TS 23.501 V17.5.0.

The network node may be any suitable network device or node or entity or function. In an embodiment, the network node may comprise at least one of network functions as described in various 3GPP specifications. For example, the network node may comprise at least one of network functions as described in clause 6.2 of 3GPP TS 23.501 V17.5.0.

In an embodiment, the network node may comprise at least one of an NF service consumer, an NRF, or a service communication proxy (SCP).

The target network function may be any suitable network device or node or entity or function. In an embodiment, the target network function may comprise at least one of network functions as described in various 3GPP specifications. For example, the target network function may comprise at least one of network functions as described in clause 6.2 of 3GPP TS 23.501 V17.5.0.

The first NF discovery request may be any suitable message such as an existing message or a new message. The first NF discovery request may further comprise any suitable query parameters. For example, the first NF discovery request may be Nnrf_NFDiscovery_Request as described in 3GPP TS 23.502 V17.5.0 except that it further comprises at least one preferred feature to be supported by a target network function.

The at least one preferred feature may be any suitable feature and the present disclosure has no limit on it. For example, a list of features preferred to be supported by the target Network Function may be same as those defined by the supportedFeatures attribute in NFService (see clauses 6.1.6.2.3 and 6.2.6.2.4 of 3GPP TS 29.510 V18.0.0).

In an embodiment, the at least one preferred feature may be present only if the service-names attribute is present.

In an embodiment, the key of the map is the Service Name as specified in clause 6.1.6.3.11 of 3GPP TS 29.510 V18.0.0. Each element carries the preferred feature(s) to be supported by the target Network Function for the indicated service.

In an embodiment, the first NRF may authorize the first network function (NF) discovery request. Based on the profile of the expected NF/NF service and the type of the NF service consumer, the first NRF may determine whether the NF service consumer is allowed to discover the expected NF instance(s). If the expected NF instance(s) or NF service instance(s) are deployed in a certain network slice, the first NRF may authorize the discovery request according to the discovery configuration of the Network Slice, e.g. the expected NF instance(s) are only discoverable by the NF in the same network slice.

At block 304, the first NRF may send a first NF discovery response to the network node.

For example, the first NRF may determine a set of NF instance(s) matching the first NF discovery request by itself. Alternatively, the first NRF may send the first NF discovery request to a second NRF and obtain a set of NF instance(s) matching the first NF discovery request from the second NRF.

For example, if the NF service consumer is allowed to discover the expected NF instance(s), the first NRF may determine a set of NF instance(s) matching the first network function (NF) discovery request and internal policies of the first NRF and sends the NF profile(s) of the determined NF instances to the NF service consumer via the first NF discovery response.

In an embodiment, the first NF discovery response may comprise at least one of first information indicating whether a search result includes at least one NF profile that supports the at least one preferred feature, or second information indicating whether the search result includes at least one NF profile that does not support the at least one preferred feature.

The first information and the second information may be any suitable information such as a bit, a flag, an indication, etc.

In an embodiment, the first information may be a Boolean value and the second information may be a Boolean value.

In an embodiment, when the first information is set to true and the second information is set to false, it indicates all returned NF instances match the at least one preferred feature.

In an embodiment, when the first information is set to false and the second information is set to true, it indicates that none of all returned NF instances matches the at least one preferred feature.

In an embodiment, when the first information is set to true and the second information is set to true, it indicates that at least one returned NF instance matches the at least one preferred feature and at least one returned NF instance does not match the at least one preferred feature.

In an embodiment, when the first information is set to false and the second information is set to false, it indicates that no NF instance can be found.

FIG. 4a shows a flowchart of a method according to another embodiment of the present disclosure, which may be performed by an apparatus implemented in or at or as a first NRF or communicatively coupled to the first NRF. As such, the apparatus may provide means or modules for accomplishing various parts of the method 400 as well as means or modules for accomplishing other processes in conjunction with other components. For some parts which have been described in the above embodiments, the description thereof is omitted here for brevity.

At block 402, optionally, the first NRF may determine at least one first NF instance matching the at least one preferred feature.

For example, when the first NF discovery request comprising at least one preferred feature to be supported by a target network function, the first NRF may determine at least one first NF instance matching the at least one preferred feature.

At block 404, optionally, the first NRF may determine at least one second NF instance not matching the at least one preferred feature.

In an embodiment, the first NF discovery response may comprise information regarding the at least one first NF instance and/or information regarding the at least one second NF instance.

In an embodiment, when the at least one first NF instance cannot be found or a number of the at least one first NF instance is smaller than a predefined number, the first NRF may determine the at least one second NF instance not matching the at least one preferred feature.

FIG. 4b shows a flowchart of a method according to another embodiment of the present disclosure, which may be performed by an apparatus implemented in or at or as a first NRF or communicatively coupled to the first NRF. As such, the apparatus may provide means or modules for accomplishing various parts of the method 410 as well as means or modules for accomplishing other processes in conjunction with other components. For some parts which have been described in the above embodiments, the description thereof is omitted here for brevity.

At block 412, optionally, the first NRF may set a priority for the at least one first NF instance.

At block 414, optionally, the first NRF may set a priority for the at least one second NF instance.

The priority may be any suitable form such as a priority value or an occurrence order, etc.

In an embodiment, the at least one first NF instance may be set with a higher priority to be selected than the at least one second NF instance.

In an embodiment, the first NF discovery response may further comprise information regarding the priority of at least one first NF instance and/or the priority of the at least one second NF instance.

FIG. 4c shows a flowchart of a method according to another embodiment of the present disclosure, which may be performed by an apparatus implemented in or at or as a first NRF or communicatively coupled to the first NRF. As such, the apparatus may provide means or modules for accomplishing various parts of the method 420 as well as means or modules for accomplishing other processes in conjunction with other components. For some parts which have been described in the above embodiments, the description thereof is omitted here for brevity.

At block 422, the first NRF may send a second NF discovery request comprising the at least one preferred feature to a second NRF.

At block 424, the first NRF may receive a second NF discovery response from the second NRF.

In an embodiment, the second NRF may determine at least one third NF instance matching the at least one preferred feature and/or determine at least one fourth NF instance not matching the at least one preferred feature.

In an embodiment, when the at least one third NF instance cannot be found or a number of the at least one third NF instance is smaller than a predefined number, the second NRF may determine the at least one fourth NF instance not matching the at least one preferred feature.

In an embodiment, the second NF discovery response comprises information regarding at least one third NF instance and/or information regarding at least one fourth NF instance. The first NF discovery response comprises the information regarding the at least one third NF instance and/or the information regarding the at least one fourth NF instance.

In an embodiment, when the at least one third NF instance cannot be found or a number of the at least one third NF instance is smaller than a predefined number, the second NF discovery response and the first NF discovery response comprise the at least one fourth NF instance not matching the at least one preferred feature.

In an embodiment, the at least one third NF instance is set with a priority and/or the at least one fourth NF instance is set with a priority.

In an embodiment, the at least one third NF instance is set with a higher priority to be selected than the at least one fourth NF instance.

In an embodiment, the second NF discovery response and the first NF discovery response further comprise information regarding the priority of at least one third NF instance and/or the priority of the at least one fourth NF instance.

In an embodiment, the second NF discovery response comprises at least one of third information indicating whether a search result includes at least one NF profile that supports the at least one preferred feature, or fourth information indicating whether the search result includes at least one NF profile that does not support the at least one preferred feature.

The third information and the fourth information may be any suitable information such as a bit, a flag, an indication, etc.

In an embodiment, the third information is a Boolean value and the fourth information is a Boolean value.

In an embodiment, when the third information is set to true and the fourth information is set to false, it indicates all returned NF instances match the at least one preferred feature.

In an embodiment, when the third information is set to false and the fourth information is set to true, it indicates that none of all returned NF instances matches the at least one preferred feature.

In an embodiment, when the third information is set to true and the fourth information is set to true, it indicates that at least one returned NF instance matches the at least one preferred feature and at least one returned NF instance does not match the at least one preferred feature.

In an embodiment, when the third information is set to false and the fourth information is set to false, it indicates that no NF instance can be found.

FIG. 4d shows a flowchart of a method according to another embodiment of the present disclosure, which may be performed by an apparatus implemented in or at or as a first NRF or communicatively coupled to the first NRF. As such, the apparatus may provide means or modules for accomplishing various parts of the method 430 as well as means or modules for accomplishing other processes in conjunction with other components. For some parts which have been described in the above embodiments, the description thereof is omitted here for brevity.

At block 432, optionally, the first NRF may receive information indicating that the second NRF supports a query parameter of preferred features from the second NRF.

For example, the second NRF may send the information indicating that the second NRF supports a query parameter of preferred features to the first NRF. Then the first NRF may know the second NRF supports the query parameter of preferred features and can send a NF discovery request comprising the at least one preferred feature to the second NRF.

In an embodiment, the first NRF may send a request for obtaining query parameters supported by the second NRF to the second NRF, and receive a response comprising the information indicating that the second NRF supports a query parameter of preferred features from the second NRF.

In an embodiment, the second NRF may advertise the information indicating that the second NRF supports a query parameter of preferred features, and then the first NRF may receive the information indicating that the second NRF supports a query parameter of preferred features from the second NRF.

At block 434, optionally, the first NRF may send information indicating that the first NRF supports a query parameter of preferred features to the network node. In this way, the network node may know the first NRF support the query parameter of preferred features and can send a NF discovery request comprising the at least one preferred feature to the first NRF.

In an embodiment, the network node may send a request for obtaining query parameters supported by the first NRF to the first NRF, and receive a response comprising the information indicating that the first NRF supports a query parameter of preferred features from the first NRF.

In an embodiment, the first NRF may advertise the information indicating that the first NRF supports a query parameter of preferred features, and then the network node may receive the information indicating that the first NRF supports a query parameter of preferred features from the first NRF.

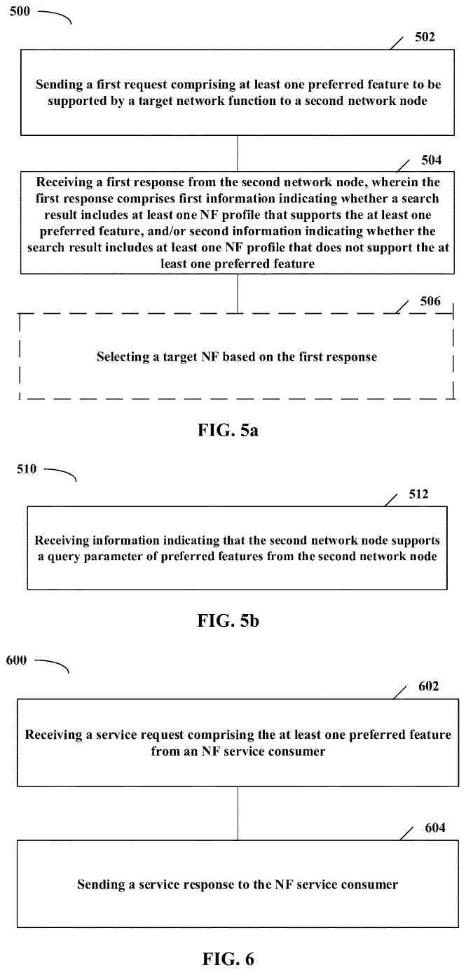

FIG. 5a shows a flowchart of a method according to another embodiment of the present disclosure, which may be performed by an apparatus implemented in or at or as a first network node or communicatively coupled to the first network node. As such, the apparatus may provide means or modules for accomplishing various parts of the method 500 as well as means or modules for accomplishing other processes in conjunction with other components. For some parts which have been described in the above embodiments, the description thereof is omitted here for brevity.

At block 502, the first network node may send a first request comprising at least one preferred feature to be supported by a target network function to a second network node.

At block 504, the first network node may receive a first response from the second network node.

The first network node may be any suitable network device or node or entity or function. In an embodiment, the first network node may comprise at least one of network functions as described in various 3GPP specifications. For example, the first network node may comprise at least one of network functions as described in clause 6.2 of 3GPP TS 23.501 V17.5.0.

In an embodiment, the first network node comprises at least one of an NF service consumer, an NRF, or a service communication proxy (SCP).

The second network node may be any suitable network device or node or entity or function. In an embodiment, the second network node comprises at least one of an NRF, or a service communication proxy (SCP).

The first request may be any suitable message such as an existing message or a new message. The first request may further comprise any suitable query parameters.

In an embodiment, the first request comprises at least one of an NF discovery request, or a service request. For example, the NF discovery request may be Nnrf_NFDiscovery_Request as described in 3GPP TS 23.502 V17.5.0 except that it further comprises at least one preferred feature to be supported by a target network function. The service request may be service request as described in clause 4.17 of 3GPP TS 23.502 V17.5.0 except that it further comprises at least one preferred feature to be supported by a target network function.

The first response may be any suitable message such as an existing message or a new message. In an embodiment, the first response comprises at least one of an NF discovery response, or a service response.

In an embodiment, the first response comprises information regarding the at least one NF instance matching the at least one preferred feature and/or information regarding the at least one NF instance not matching the at least one preferred feature.

In an embodiment, when the at least one NF instance matching the at least one preferred feature cannot be found or a number of the at least one NF instance matching the at least one preferred feature is smaller than a predefined number, the first response comprises the at least one NF instance not matching the at least one preferred feature.

In an embodiment, the at least one NF instance matching the at least one preferred feature is set with a priority and/or the at least one NF instance not matching the at least one preferred feature is set with a priority.

In an embodiment, the at least one NF instance matching the at least one preferred feature is set with a higher priority to be selected than the at least one NF instance not matching the at least one preferred feature.

In an embodiment, the first response further comprises information regarding the priority of at least one NF instance matching the at least one preferred feature and/or the priority of the at least one NF instance not matching the at least one preferred feature.

In an embodiment, the first response comprises at least one of first information indicating whether a search result includes at least one NF profile that supports the at least one preferred feature, or second information indicating whether the search result includes at least one NF profile that does not support the at least one preferred feature.

In an embodiment, the first information is a Boolean value and the second information is a Boolean value.

In an embodiment, when the first information is set to true and the second information is set to false, it indicates all returned NF instances match the at least one preferred feature.

In an embodiment, when the first information is set to false and the second information is set to true, it indicates that none of all returned NF instances matches the at least one preferred feature.

In an embodiment, when the first information is set to true and the second information is set to true, it indicates that at least one returned NF instance matches the at least one preferred feature and at least one returned NF instance does not match the at least one preferred feature.

In an embodiment, when the first information is set to false and the second information is set to false, it indicates that no NF instance can be found.

At block 506, optionally, the first network node may select a target NF based on the first response.

For example, upon successful NF discovery response with provided indications, the first network node may select the target NF based on priority, which may be the target NF supporting preferred features if exists. Otherwise the first network node may select the target NF not supporting preferred features when no such NFs matching preferred features exist. The first network node can proceed to interact with the target NF with knowledge of the feature capability.

FIG. 5b shows a flowchart of a method according to another embodiment of the present disclosure, which may be performed by an apparatus implemented in or at or as a first network node or communicatively coupled to the first network node. As such, the apparatus may provide means or modules for accomplishing various parts of the method 510 as well as means or modules for accomplishing other processes in conjunction with other components. For some parts which have been described in the above embodiments, the description thereof is omitted here for brevity.

At block 512, the first network node may receive information indicating that the second network node supports a query parameter of preferred features from the second network node. In this way, the first network node may know the second network node supports the query parameter of preferred features and can send a NF discovery request comprising the at least one preferred feature to the second network node.

In an embodiment, the first network node may send a request for obtaining query parameters supported by the second network node to the second network node, and receive a response comprising the information indicating that the second network node supports a query parameter of preferred features from the second network node.

In an embodiment, the second network node may advertise the information indicating that the second network node supports a query parameter of preferred features, and then the first network node may receive the information indicating that the second network node supports a query parameter of preferred features from the second network node.

FIG. 6 shows a flowchart of a method according to another embodiment of the present disclosure, which may be performed by an apparatus implemented in or at or as a first network node or communicatively coupled to the first network node. As such, the apparatus may provide means or modules for accomplishing various parts of the method 600 as well as means or modules for accomplishing other processes in conjunction with other components. For some parts which have been described in the above embodiments, the description thereof is omitted here for brevity.

In this embodiment, the first network node is an SCP and the second network node is an NRF.

At block 602, the first network node may receive a service request comprising the at least one preferred feature from an NF service consumer.

At block 604, the first network node may send a service response to the NF service consumer.

In an embodiment, it may introduce a new query parameter like “preferred-features” in Nnrf_NFDiscovery service.

In an embodiment, when the query parameter is present in the NF discovery request, the NRF may prefer to return NF profiles with SupportedFeatures attribute in NFService matching the “preferred-features”, and also additional NFs not matching the preferred features. The additional NFs may be set to a lower priority than the matched ones.

In an embodiment, in NF Discovery response, the NRF may also return additional indications to the NF service consumer about whether matched NF instances are returned and/or no matched NF instances are returned, which can help the NF service consumer to better communicate with the NF service producer.

In an embodiment, to help the NF service consumer efficiently discover the candidate NF service producers based on mandatory and preferred features, it is recommended to allow the NF service consumer to indicate the preferred features in the discovery request besides the required features. The NRF may prioritize the matched candidates supporting preferred features in the search result.

In an embodiment, the proposed solution is to add a new query parameter “preferred-features” in NF discovery request. Upon the new query parameter, the NRF may find NF Profiles with NF Service Profile matching the preferred features, and also additional NF Profiles not matching the preferred features.

In an embodiment, the NRF may return target NFs matching the preferred features, which can help the NF service consumer to be able to select the NF service producer supporting same supported features.

In an embodiment, the NFs not matching preferred features can also be returned in NF discovery response, which may be set a lower priority than the matched ones. It can cover the scenario where no matched NF instances exist in NRF. It can also bring benefit during NF reselection to provide more candidates.

In an embodiment, the proposed solution can provide a new approach when discovering target NF instances supporting specific features. It can help to reduce NF discovery signaling and to better support the feature negotiation mechanism.

In an embodiment, when the NF service consumer has supported some additional features in the API, it may prefer to discover NF service producers supporting these specific features, and the functions brought by the supported features can be performed in the API interface. If no such NF service producers matching the preferred features exist in NRF, the NF service consumer may want to find NF service producers not matching the preferred features, since basic functions in the API interface can still be performed.

In an embodiment, the proposed solution is to add one new query parameter “preferred-features” in Nnrf_NFDiscovery service for NRF to return NFs matching the preferred features, and also additional NFs not matching the preferred features. The additional NFs may be set to a lower priority compared with the NFs matching the specific features.

In an embodiment, to better indicate whether target NF Instances matching the required specific features are found and whether NF Instances not supporting the specific feature are returned, two new Indications (preferredFeaturesMatchInd and noPreferredFeaturesInd) are added in NF discovery response:
When preferredFeaturesMatchInd is set to true and noPreferredFeaturesInd is set to false, it means all returned NF Instances match the required specific features.
When preferredFeaturesMatchInd is set to false and noPreferredFeaturesInd is set to true, it means that none of the NF Instances matches the required specific features.
When preferredFeaturesMatchInd is set to true and noPreferredFeaturesInd is set to true, it means that in the NF discovery response, NF Instances matching the required specific features and additional NF Instances not matching the required specific features are both returned.
When preferredFeaturesMatchInd is set to false and noPreferredFeaturesInd is set to false, it means that no NF Instances can be found in NRF.

In an embodiment, upon successful NF discovery response with provided indications, the NF service consumer selects target NF based on priority, which shall be the NF service producer supporting preferred features if exists. Otherwise the NF service consumer selects the NF service producer not supporting preferred features when no such NFs matching preferred features exist. The NF service consumer can proceed to interact with the target NF with knowledge of the feature capability.

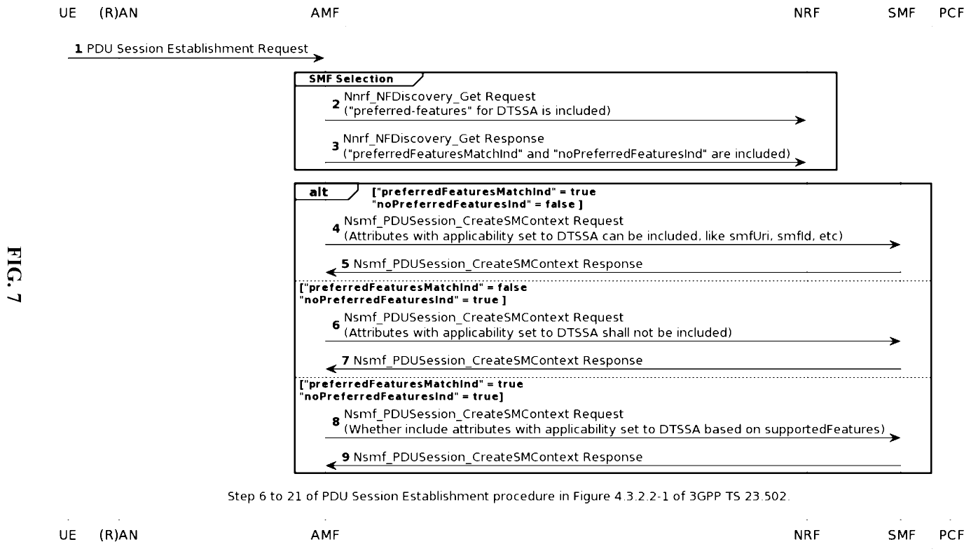

FIG. 7 shows a flowchart of NF discovery according to an embodiment of the present disclosure. It shows an example of the usage of newly added query parameter and indications in NF Service Discovery Service. The example is that AMF as NF service consumer wants to discover SMF supporting DTSSA feature during PDU Session Establishment procedure when “preferred-features” query parameter is introduced.

In Step 1, UE sends a PDU Session Establishment Request to AMF.

In Step 2, the AMF sends an Nnrf_NFDiscovery_Request message to the NRF with “preferred-features” indicating preferring to select SMF supporting DTSSA feature by Nsmf_PDUSession service.

In Step 3, the NRF responds with an Nnrf_NFDiscovery_Request Response message with selected SMF Instances. Since “preferred-features” is included in query parameter, “preferredFeaturesMatchInd” and “noPreferredFeaturesInd” attributes are included to indicate whether the returned SMF instances match the preferred features.

In Step 4, the AMF has received NF discovery response with “preferredFeaturesMatchInd” attribute set to true and “noPreferredFeaturesInd” attribute set to false, which means all returned SMF Instances support DTSSA. The AMF sends an Nsmf_PDUSession_CreateSMContext Request message to the SMF, attributes with applicability set to DTSSA can be included, like smfUri (SMF URI (Uniform Resource Identifier)), smfId (SMF identifier), etc.

In Step 5, the SMF responds with an Nsmf_PDUSession_CreateSMContext Response message.

In Step 6, the AMF has received NF discovery response with “preferredFeaturesMatchInd” attribute set to false and “noPreferredFeaturesInd” attribute set to true, which means all returned SMF instances don't support DTSSA. The AMF sends an Nsmf_PDUSession_CreateSMContext Request message to the SMF, attributes with applicability set to DTSSA shall not be included.

In Step 7, the SMF responds with an Nsmf_PDUSession_CreateSMContext Response message.

In Step 8, the AMF has received NF discovery response with “preferredFeaturesMatchInd” attribute set to true and “noPreferredFeaturesInd” attribute set to true, which means some returned SMF Instances support DTSSA while the others are not. The SMF instances supporting DTSSA will be set to a higher priority. The AMF sends an Nsmf_PDUSession_CreateSMContext Request message to the SMF, whether including attributes with applicability set to DTSSA depends on the supportedFeatures of the selected SMF.

In Step 9, the SMF responds with an Nsmf_PDUSession_CreateSMContext Response message.

Then steps 6 to 21 of PDU Session Establishment procedure in FIG. 4.3.2.2-1 of 3GPP TS 23.502 V17.5.0 may be performed.

Based on the proposed solution to add new query parameters and indications in Nnrf_NFDiscovery service, the AMF only needs to send NF discovery request for one time and can know how to interact with SMF based on the returned search result.

Some messages of FIG. 7 may be same as the corresponding messages as described in various 3GPP specifications such as 3GPP TS 23.502 V17.5.0. Some messages of FIG. 9 are enhanced according to embodiments of the present disclosure.

In an embodiment, the following content may be added into Table 6.2.3.2.3.1-1 of 3GPP TS 29.510 V18.0.0.

TABLE 6.2.3.2.3.1-1
URI query parameters supported by the GET method on this resource

| Name | Data type | P | Cardinality | Description | Applicability |
|---|---|---|---|---|---|
| preferred- | map(SupportedFeatures) | O | 1 . . . N | List of features preferred to be supported by the target Network | Query- |
| features | | | | Function, as defined by the supportedFeatures attribute in NFService | SBIProtoc18 |
| | | | | (see clauses 6.1.6.2.3 and 6.2.6.2.4 Of 3GPP TS 29.510 V18.0.0). | |
| | | | | This IE may be present only if the service-names attribute is present. | |
| | | | | The key of the map is the Service Name as specified in | |
| | | | | clause 6.1.6.3.11 Of 3GPP TS 29.510 V18.0.0. Each element carries | |
| | | | | the preferred feature(s) to be supported by the target Network | |
| | | | | Function for the indicated service. | |

Table 6.2.3.2.3.1-1 defines URI query parameters supported by the GET method, and a new query parameter “preferred-features” is added in Table 6.2.3.2.3.1-1.

In an embodiment, the following content may be added into Table 6.2.6.2.6-1 of 3GPP TS 29.510 V18.0.0.

TABLE 6.2.6.2.6-1
Definition of type PreferredSearch

| Attribute name | Data type | P | Cardinality | Description |
|---|---|---|---|---|
| preferredFeaturesMatchInd | boolean | O | 0 . . . 1 | Indicates whether the search result includes at least one |
| | | | | NFProfile that supports the preferred feature(s) indicated |
| | | | | by the query parameter preferred-features. |
| | | | | true: Supported |
| | | | | false (default): Not supported |
| noPreferredFeaturesInd | boolean | O | 0 . . . 1 | Indicates whether the search result includes at least one |
| | | | | NFProfile not supporting the preferred feature(s) indicated |
| | | | | by the query parameter preferred-features. |
| | | | | true: Returned |
| | | | | false (default): Not returned |

Table 6.2.6.2.6-1 defines the type of PreferredSearch and two new Indications (preferredFeaturesMatchInd and noPreferredFeaturesInd) are added in Table 6.2.6.2.6-1.

In an embodiment, the following underline content may be added into Table 6.2.9-1 of 3GPP TS 29.510 V18.0.0.

TABLE 6.2.9-1
Features of supportedFeatures attribute used by Nnrf_NFDiscovery service

| Feature | | | |
|---|---|---|---|
| Number | Feature | M/O | Description |
| 29 | Query-SBIProtoc18 | O | Support of the following query parameters, for Service Based Interface |
| | | | Protocol Improvements defined in 3GPP Rel-18: |
| | | | ext-preferred-locality |
| | | | preferred-features |

Table 6.2.9-1 defines the supported features for the Nurf_NFDiscovery service. The usage of Query-Params-Ext2 is extended to control the support of the newly added query parameter “preferred-features”.

In an embodiment, the following underline content may be added into Nurf_NFDiscovery API of 3GPP TS 29.510 V18.0.0.

```
A.3 Nnrf_NFDiscovery API
openapi: 3.0.0
******************** Text Skipped for Clarity **********************
paths:
  /nf-instances:
    get:
      summary: Search a collection of NF Instances
      operationId: SearchNFInstances
      tags:
        - NF Instances (Store)
      parameters:
        ...
        - name: exclude-nfserviceset-list
          in: query
          description: NF Service Set IDs to be excluded from the NF Discovery procedure
          schema:
            type: array
            items:
              $ref: ‘TS29571_CommonData.yaml#/components/schemas/NfServiceSetId’
            minItems: 1
          style: form
          explode: false
        - name: exclude-nfset-list
          in: query
          description: NF Set IDs to be excluded from the NF Discovery procedure
          schema:
            type: array
            items:
              $ref: ‘TS29571_CommonData.yaml#/components/schemas/NfSetId’
            minItems: 1
          style: form
          explode: false
        - name: preferred-analytics-delays
          in: query
          description: Preferred analytics delays supported by the NWDAF to be discovered
          content:
            application/json:
              schema:
                description: >
                  A map (list of key-value pairs) where EventId or NwdafEvent serves as key
                type: object
                additionalProperties:
                  $ref: ‘TS29571_CommonData.yaml#/components/schemas/DurationSec’
                minProperties: 1
        - name: preferred-features
          in: query
          description: Preferred features to be supported by the target Network Function.
          content:
            application/json:
              schema:
                description: >
                  A map (list of key-value pairs) where Service Name serves as the key.
                type: object
                additionalProperties:
                  $ref:
‘TS29571_CommonData.yaml#/components/schemas/SupportedFeatures
                minProperties: 1
      responses:
        ‘200’:
          description: Expected response to a valid request
          content:
            application/json:
              schema:
                $ref: ‘#/components/schemas/SearchResult’
          links:
            search:
              operationId: RetrieveStoredSearch
              parameters:
                searchId: $response.body#/searchId
              description: >
                The ‘searchId’ parameter returned in the response can be used as the
                ‘searchId’ parameter in the GET request to ‘/searches/{searchId}’
            completeSearch:
              operationId: RetrieveCompleteSearch
              parameters:
                searchId: $response.body#/searchId
              description: >
                The ‘searchId’ parameter returned in the response can be used as the
                ‘searchId’ parameter in the GET request to ‘/searches/{searchId}/complete’
          headers:
            Cache-Control:
              description: Cache-Control containing max-age, described in IETF RFC 7234, 5.2
              schema:
                type: string
            ETag:
              description: Entity Tag containing a strong validator, described in IETF RFC 7232, 2.3
              schema:
                type: string
            Content-Encoding:
              description: Content-Encoding, described in IETF RFC 7231
              schema:
                type: string
        ‘307’:
          description: Temporary Redirect
          content:
            application/json:
              schema:
                $ref: ‘TS29571_CommonData.yaml#/components/schemas/RedirectResponse’
          headers:
            Location:
              description: The URI pointing to the resource located on the redirect target NRF
              required: true
              schema:
                type: string
        ‘308’:
          description: Permanent Redirect
          content:
            application/json:
              schema:
                $ref: ‘TS29571_CommonData.yaml#/components/schemas/RedirectResponse’
          headers:
            Location:
              description: The URI pointing to the resource located on the redirect target NRF
              required: true
              schema:
                type: string
        ‘400’:
          $ref: ‘TS29571_CommonData.yaml#/components/responses/400’
        ‘401’:
          $ref: ‘TS29571_CommonData.yaml#/components/responses/401’
        ‘403’:
          $ref: ‘TS29571_CommonData.yaml#/components/responses/403’
        ‘404’:
          $ref: ‘TS29571_CommonData.yaml#/components/responses/404’
        ‘406’:
          $ref: ‘TS29571_CommonData.yaml#/components/responses/406’
        ‘411’:
          $ref: ‘TS29571_CommonData.yaml#/components/responses/411’
        ‘413’:
          $ref: ‘TS29571_CommonData.yaml#/components/responses/413’
        ‘415’:
          $ref: ‘TS29571_CommonData.yaml#/components/responses/415’
        ‘429’:
          $ref: ‘TS29571_CommonData.yaml#/components/responses/429’
        ‘500’:
          $ref: ‘TS29571_CommonData.yaml#/components/responses/500’
        ‘501’:
          $ref: ‘TS29571_CommonData.yaml#/components/responses/501’
        ‘503’:
          $ref: ‘TS29571_CommonData.yaml#/components/responses/503’
        default:
          $ref: ‘TS29571_CommonData.yaml#/components/responses/default’
******************** Text Skipped for Clarity **********************
    PreferredSearch:
      description: >
        Contains information on whether the returned NFProfiles match the preferred query parameters
      type: object
      properties:
        preferredTaiMatchInd:
          type: boolean
          default: false
        preferredFullPlmnMatchInd:
          type: boolean
          default: false
        preferredApiVersionsMatchInd:
          type: boolean
        otherApiVersionsInd:
          type: boolean
        preferredLocalityMatchInd:
          type: boolean
          default: false
        otherLocalityInd:
          type: boolean
          default: false
        preferredVendorSpecificFeaturesInd:
          type: boolean
          default: false
        preferredCollocatedNfTypeInd:
          type: boolean
          default: false
        preferredPgwMatchInd:
          type: boolean
        preferredAnalyticsDelaysInd:
          type: boolean
        preferredFeaturesMatchInd:
          type: boolean
        noPreferredFeaturesInd:
          type: boolean
******************** Text Skipped for Clarity **********************
```

Embodiments herein may provide many advantages, of which a non-exhaustive list of examples follows. In some embodiments herein, a new query parameter “preferred-features” can be utilized in NF discovery request, which can provide a new approach for discovering target NF instances supporting specific features. As all supported NF instances can be retrieved in one-time NF discovery, and the NF Instances matching the preferred features are of higher priority than the not matched ones. In some embodiments herein, the proposed solution can help to reduce NF discovery signaling. In some embodiments herein, the proposed solution can help to provide more available NF candidates during NF reselection. In some embodiments herein, in the NF discovery response, the NRF can provide indications about whether matched NF instances are found, and/or whether not matched NF instances are included. In some embodiments herein, the NF service consumer can decide how to interact with NF service producer based on the provided indications, which can better support the feature negotiation mechanism. The embodiments herein are not limited to the features and advantages mentioned above. A person skilled in the art will recognize additional features and advantages upon reading the following detailed description.

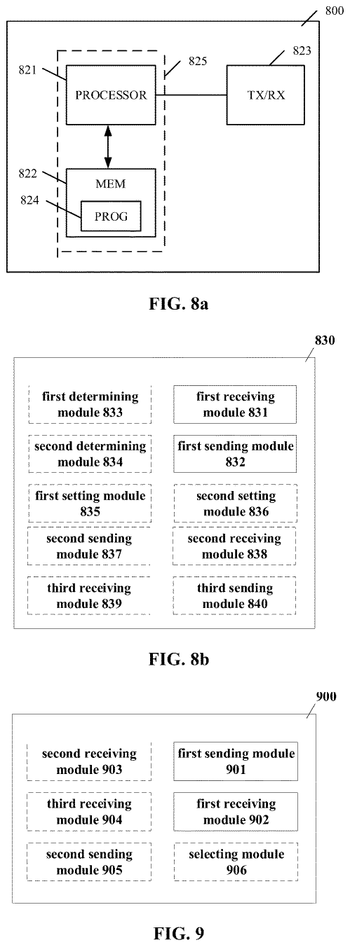

FIG. 8a is a block diagram showing an apparatus suitable for practicing some embodiments of the disclosure. For example, the first NRF or the first network node described above may be implemented as or through the apparatus 800.

The apparatus 800 comprises at least one processor 821, such as a digital processor (DP), and at least one memory (MEM) 822 coupled to the processor 821. The apparatus 800 may further comprise a transmitter TX and receiver RX 823 coupled to the processor 821. The MEM 822 stores a program (PROG) 824. The PROG 824 may include instructions that, when executed on the associated processor 821, enable the apparatus 800 to operate in accordance with the embodiments of the present disclosure. A combination of the at least one processor 821 and the at least one MEM 822 may form processing means 825 adapted to implement various embodiments of the present disclosure.

Various embodiments of the present disclosure may be implemented by computer program executable by one or more of the processor 821, software, firmware, hardware or in a combination thereof.

The MEM 822 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 821 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the first NRF, the memory 822 contains instructions executable by the processor 821, whereby the first NRF operates according to any of the methods related to the first NRF as described above.

In an embodiment where the apparatus is implemented as or at the first network node, the memory 822 contains instructions executable by the processor 821, whereby the first network node operates according to any of the methods related to the first network node as described above.

FIG. 8b is a block diagram showing a first NRF according to an embodiment of the disclosure. As shown, the first NRF 830 comprises a first receiving module 831 configured to receive a first network function (NF) discovery request comprising at least one preferred feature to be supported by a target network function from an NF. The first NRF 830 further comprises a first sending module 832 configured to send a first NF discovery response to the network node.

In an embodiment, the first NRF 830 further comprises a first determining module 833 configured to determine at least one first NF instance matching the at least one preferred feature.

In an embodiment, the first NRF 830 further comprises a second determining module 834 configured to determine at least one second NF instance not matching the at least one preferred feature. The first NF discovery response comprises information regarding the at least one first NF instance and/or information regarding the at least one second NF instance.

In an embodiment, the first NRF 830 further comprises a first setting module 835 configured to set a priority for the at least one first NF instance.

In an embodiment, the first NRF 830 further comprises a second setting module 836 configured to set a priority for the at least one second NF instance. The at least one first NF instance is set with a higher priority to be selected than the at least one second NF instance. The first NF discovery response further comprises information regarding the priority of at least one first NF instance and/or the priority of the at least one second NF instance.

In an embodiment, the first NRF 830 further comprises a second sending module 837 configured to send a second NF discovery request comprising the at least one preferred feature to a second NRF.

In an embodiment, the first NRF 830 further comprises a second receiving module 838 configured to receive a second NF discovery response from the second NRF.

In an embodiment, the first NRF 830 further comprises a third receiving module 839 configured to receive information indicating that the second NRF supports a query parameter of preferred features from the second NRF.

In an embodiment, the first NRF 830 further comprises a third sending module 840 configured to send information indicating that the first NRF supports a query parameter of preferred features to the network node.

FIG. 9 is a block diagram showing a first network node according to an embodiment of the disclosure. As shown, the first network node 900 comprises a first sending module 901 configured to send a first request comprising at least one preferred feature to be supported by a target network function to a second network node. The first network node 900 further comprises a first receiving module 902 configured to receive a first response from the second network node.

In an embodiment, the first network node 900 further comprises a second receiving module 903 configured to receive information indicating that the second network node supports a query parameter of preferred features from the second network node.

In an embodiment, the first network node 900 further comprises a third receiving module 904 configured to receive a service request comprising the at least one preferred feature from an NF service consumer.

In an embodiment, the first network node 900 further comprises a second sending module 905 configured to send a service response to the NF service consumer.

In an embodiment, the first network node 900 further comprises a selecting module 906 configured to select a target NF based on the first response.

The term unit or module may have conventional meaning in the field of electronics, electrical devices and or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the first NRF or the first network node may not need a fixed processor or memory, any computing resource and storage resource may be arranged from the first NRF or the first network node in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by a first network repository function (NRF), the method comprising:
receiving a first network function (NF) discovery request comprising at least one preferred feature to be supported by a target network function from a network node;
sending a first NF discovery response to the network node; and
the first NF discovery response comprising one or both first information indicating whether a search result includes at least one NF profile that supports the at least one preferred feature, and second information indicating whether the search result includes at least one NF profile that does not support the at least one preferred feature.

2. (canceled)

3. The method according to claim 1, wherein:
when the first information is set to true and the second information is set to false, it indicates all returned NF instances match the at least one preferred feature;
when the first information is set to false and the second information is set to true, it indicates that none of all returned NF instances matches the at least one preferred feature;
when the first information is set to true and the second information is set to true, it indicates that at least one returned NF instance matches the at least one preferred feature and at least one returned NF instance does not match the at least one preferred feature; and
when the first information is set to false and the second information is set to false, it indicates that no NF instance can be found.

4.-6. (canceled)

7. The method according to claim 1, further comprising:
one or both:
determining at least one first NF instance matching the at least one preferred feature; and
determining at least one second NF instance not matching the at least one preferred feature; and
wherein the first NF discovery response comprises one or both information regarding the at least one first NF instance and information regarding the at least one second NF instance.

8. The method according to claim 7, wherein determining at least one second NF instance not matching the at least one preferred feature comprises:
when the at least one first NF instance cannot be found or a number of the at least one first NF instance is smaller than a predefined number, determining the at least one second NF instance not matching the at least one preferred feature.

9. The method according to claim 7, further comprising:
one or both:
setting a priority for the at least one first NF instance; and
setting a priority for the at least one second NF instance;
wherein the at least one first NF instance is set with a higher priority to be selected than the at least one second NF instance; and
wherein the first NF discovery response further comprises information regarding one or both of the priority of at least one first NF instance and the priority of the at least one second NF instance.

10. The method according to 9 claim 1, further comprising:
sending a second NF discovery request comprising the at least one preferred feature to a second NRF; and
receiving a second NF discovery response from the second NRF.

11. The method according to claim 10, wherein the second NF discovery response and the first NF discovery response comprise one or both information regarding at least one third NF instance matching the at least one preferred feature and information regarding at least one fourth NF instance not matching the at least one preferred feature.

12.-20. (canceled)

21. The method according to claim 1, further comprising:
sending information indicating that the first NRF supports a query parameter of preferred features to the network node.

22. The method according to claim 1, wherein the network node comprises at least one of:
an NF service consumer;
an NRF; or
a service communication proxy (SCP).

23. A method performed by a first network node, the method comprising:
sending a first request comprising at least one preferred feature to be supported by a target network function to a second network node;
receiving a first response from the second network node; and
the first response comprising one or both first information indicating whether a search result includes at least one NF profile that supports the at least one preferred feature, and second information indicating whether the search result includes at least one NF profile that does not support the at least one preferred feature.

24. (canceled)

25. The method according to claim 23, wherein:
when the first information is set to true and the second information is set to false, it indicates all returned NF instances match the at least one preferred feature;
when the first information is set to false and the second information is set to true, it indicates that none of all returned NF instances matches the at least one preferred feature;
when the first information is set to true and the second information is set to true, it indicates that at least one returned NF instance matches the at least one preferred feature and at least one returned NF instance does not match the at least one preferred feature; and
when the first information is set to false and the second information is set to false, it indicates that no NF instance can be found.

26.-28. (canceled)

29. The method according to claim 23, wherein the first response comprises one or both information regarding the at least one NF instance matching the at least one preferred feature and information regarding the at least one NF instance not matching the at least one preferred feature.

30. The method according to claim 29, wherein when the at least one NF instance matching the at least one preferred feature cannot be found or a number of the at least one NF instance matching the at least one preferred feature is smaller than a predefined number, the first response comprises the at least one NF instance not matching the at least one preferred feature.

31. The method according to claim 29,
wherein one or both of the at least one NF instance matching the at least one preferred feature is set with a priority and the at least one NF instance not matching the at least one preferred feature is set with a priority; or
wherein the at least one NF instance matching the at least one preferred feature is set with a higher priority to be selected than the at least one NF instance not matching the at least one preferred feature; or
wherein the first response further comprises information regarding the priority of at least one NF instance matching the at least one preferred feature and/or the priority of the at least one NF instance not matching the at least one preferred feature.

32. The method according to claim 23, further comprising:
receiving information indicating that the second network node supports a query parameter of preferred features from the second network node.

33. The method according to claim 23, wherein the first network node comprises at least one of:
an NF service consumer;
an NRF; or
a service communication proxy (SCP); and
wherein the second network node comprises at least one of:
an NRF; or
a service communication proxy (SCP).

34. (canceled)

35. The method according to claim 23,
wherein the first request comprises at least one of:
an NF discovery request; or
a service request; and
wherein the first response comprises at least one of:
an NF discovery response; or
a service response.

36. (canceled)

37. (canceled)

38. A first NRF, comprising:
a processor; and
a memory coupled to the processor, the memory containing instructions executable by the processor, whereby the first NRF is operative to:
receive a first network function (NF) discovery request comprising at least one preferred feature to be supported by a target network function from a network node;
send a first NF discovery response to the network node; and
the first NF discovery response comprising one or both first information indicating whether a search result includes at least one NF profile that supports the at least one preferred feature, and second information indicating whether the search result includes at least one NF profile that does not support the at least one preferred feature.

39. (canceled)

40. A first network node, comprising:
a processor; and
a memory coupled to the processor, the memory containing instructions executable by the processor, whereby the first network node is operative to:
send a first request comprising at least one preferred feature to be supported by a target network function to a second network node;
receive a first response from the second network node; and
the first response comprising one or both first information indicating whether a search result includes at least one NF profile that supports the at least one preferred feature, second information indicating whether the search result includes at least one NF profile that does not support the at least one preferred feature.

41.-43. (canceled)
